(19) United States
(12) Patent Application Publication
(10) Pub. No.: US 2009/0254748 A1
(43) Pub. Date: Oct. 8, 2009

(54) ELECTRONIC MAIL GATEWAY APPARATUS

(75) Inventor: Yusuke MOCHIZUKI, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/400,020

(22) Filed: Mar. 9, 2009

(30) Foreign Application Priority Data
Apr. 4, 2008 (JP) 2008-098280

(51) Int. Cl. G06F 15/16; H04L 9/32

(52) U.S. Cl. 713/168; 709/206

(57) ABSTRACT

An e-mail gateway apparatus is configured to delete unnecessary e-mails that are on an e-mail server apparatus. When the S/MIME gateway apparatus fails to receive an e-mail from the e-mail server apparatus, a main control unit of the S/MIME gateway apparatus distributes to a client PC an error notification mail indicating the failure. When a deletion request signal requesting deletion of the reception-failed e-mail is received from the client PC, the main control unit of the S/MIME gateway apparatus requests the e-mail server apparatus to delete the e-mail.

### CROSS-REFERENCE TO RELATED APPLICATIONS

This application claims priority under 35 U.S.C. 119 to Japanese Patent Application No. 2008-098280, filed on Apr. 4, 2008, which application is hereby incorporated by reference in its entirety.

### BACKGROUND OF THE INVENTION

1. Field of the Invention

The present invention relates to an electronic mail (e-mail) gateway apparatus that receives e-mails addressed to a client apparatus from an e-mail server apparatus and, in response to an e-mail-reception-requesting command received from the client apparatus, distributes the e-mails received from the e-mail server apparatus to the client apparatus.

2. Description of the Related Art

Electronic data, such as text data and image data, is often transmitted and received through e-mails because e-mails are advantageous in terms of convenience and promptness. A conventional e-mail server apparatus operates as a mail box that distributes e-mails to a client apparatus. Another suggested e-mail server apparatus operates as an e-mail gateway apparatus that temporarily stores e-mails received from an external e-mail server in a mail box arranged in the e-mail gateway apparatus and distributes the e-mails to a client apparatus arranged in a Local Area Network (LAN) thereafter.

When a data size of an e-mail exceeds an amount of free space of a mail box or a predetermined threshold value, the e-mail is not received, and a destination user is notified of reception failure. In an e-mail way apparatus, in particular, it is necessary to limit reception based on an e-mail size. However, a problem occurs in which, when the e-mail gateway apparatus fails to receive an e-mail from an e-mail server apparatus, the e-mail remains in the e-mail server apparatus.

### SUMMARY OF THE INVENTION

In order to overcome the problems described above, preferred embodiments of the present invention provide an e-mail gateway apparatus that is arranged to distribute e-mails from an e-mail server apparatus to a client apparatus and to delete unnecessary e-mails that are on the e-mail server apparatus.

According to a preferred embodiment of the present invention, an e-mail gateway apparatus includes a reception unit arranged to receive e-mails addressed to a client apparatus from an e-mail server apparatus; an error notification distribution unit arranged to distribute an error notification mail indicating a failure to the client apparatus when the reception unit fails to receive the e-mail from the e-mail server apparatus; and a deletion request unit arranged to request the e-mail server apparatus to delete the e-mail when a deletion request signal requesting the deletion of the reception-failed e-mail is received from the client apparatus.

In the e-mail gateway apparatus according to the above preferred embodiment of the present invention, the deletion request signal defines a reply mail responding to the error notification mail.

According to a preferred embodiment of the present invention, the e-mail gateway apparatus is arranged to generate a web page arranged to receive the input from the client apparatus and includes a web server apparatus that can transmit a reply signal including the web page to the client apparatus in response to a first request signal transmitted from the client apparatus. The deletion request signal defines a second request signal transmitted from the client apparatus, the deletion request signal including a deletion request that is input to the web page by the client apparatus in response to the reply signal.

A preferred embodiment of the present invention provides an e-mail gateway apparatus arranged to distribute e-mails from an e-mail server apparatus to a client apparatus, the e-mail gateway apparatus being able to delete unnecessary e-mails that are on the e-mail server apparatus.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a configuration of a LAN system including a Secure Multipurpose Internet Mail Extensions (S/MIME) gateway apparatus 20 having an e-mail transmitting/receiving function using S/MIME according to a preferred embodiment of the present invention.

FIG. 2 is a block diagram illustrating a configuration of a client personal computer 30 of FIG. 1 according to a preferred embodiment of the present invention.

FIG. 3 is a block diagram illustrating a configuration of the S/MIME gateway apparatus 20 of FIG. 1 according to a preferred embodiment of the present invention.

FIG. 4 is a block diagram illustrating a configuration of an e-mail server apparatus 40 of FIG. 1 according to a preferred embodiment of the present invention.

FIG. 5 is a flowchart representing an e-mail receiving process executed through a main control unit 1 of the S/MIME gateway apparatus 20 of FIG. 3 according to a preferred embodiment of the present invention.

FIG. 6 is a flowchart representing an e-mail deleting process executed through the main control unit 1 of the S/MIME gateway apparatus 20 of FIG. 3 according to a preferred embodiment of the present invention.

FIG. 7 is an example of an error notification mail transmitted from the S/MIME gateway apparatus 20 of FIG. 1 to the client PC 30 according to a preferred embodiment of the present invention.

FIG. 8 is an example of a reply mail transmitted from the client PC 30 of FIG. 1 to the S/MIME gateway apparatus 20 in response to the error notification mail of FIG. 7 according to a preferred embodiment of the present invention.

### DETAILED DESCRIPTION OF PREFERRED EMBODIMENTS

Preferred embodiments of the present invention will now be described with reference to the drawings.

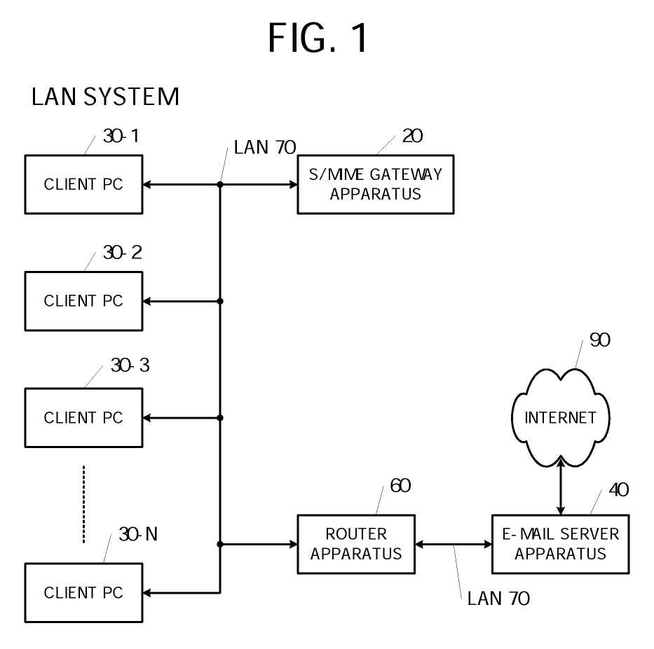

FIG. 1 is a block diagram illustrating a configuration of a LAN system including an S/MIME gateway apparatus 20 having an e-mail transmitting/receiving function using S/MIME according to a preferred embodiment of the present invention.

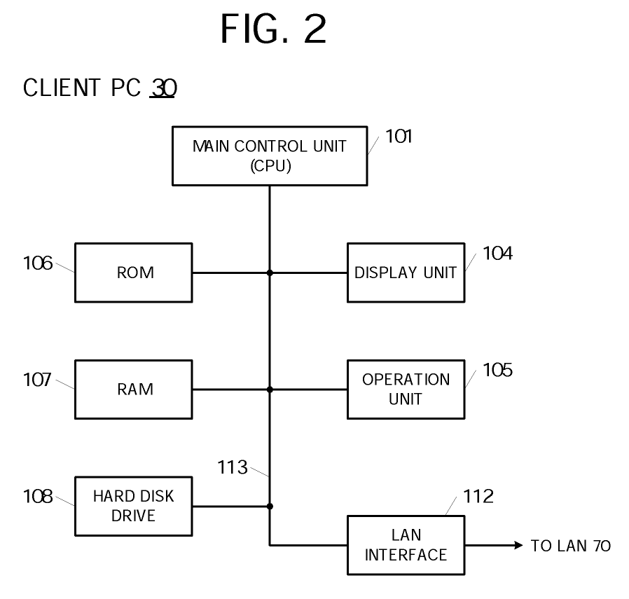

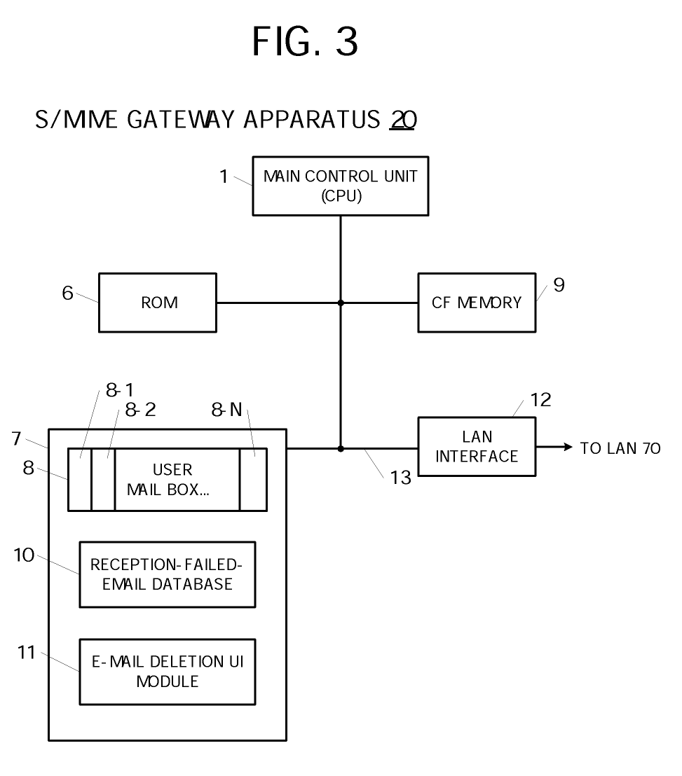

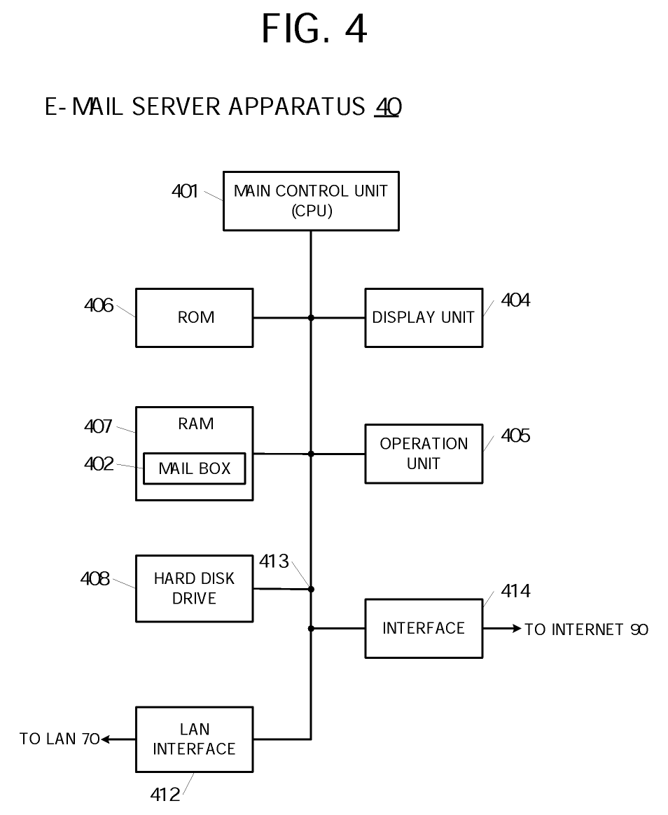

According to the present preferred embodiment, a plurality of client PCs 30-1 through 30-N (hereinafter, collectively referred to as the client PC 30), the S/MIME gateway apparatus 20, a router apparatus 60, and an e-mail server apparatus 40 connected to the Internet 90, are connected with each other via a LAN 70 in a LAN system. FIG. 2 is a block diagram illustrating a configuration of the client PC 30 of FIG. 1. FIG. 3 is a block diagram illustrating a configuration of the S/MIME gateway apparatus 20 of FIG. 1. FIG. 4 is a block diagram illustrating a configuration of the e-mail server apparatus 40 of FIG. 1.

In the present preferred embodiment, when transmitting and receiving e-mails, each of the client PCs 30 communicates with the S/MIME gateway apparatus 20, and the S/MIME gateway apparatus 20 communicates with the e-mail server apparatus 40 via the router apparatus 60. In the following description, the S/MIME gateway apparatus 20 communicates with the e-mail server apparatus 40 via the router apparatus 60 even when the router apparatus 60 is not particularly referred to. Each of the client PCs 30 includes only a function of transmitting/receiving plain text e-mails, however, as described below in detail, by communicating with the e-mail server apparatus 40 via the S/MIME gateway apparatus 20, each of the client PCs 30 can use the functions of encryption, decryption, electronic signature, electronic signature validation, etc. through S/MIME.

With reference to FIG. 2, the configuration of the client PC 30 will now be described.

In FIG. 2, the client PC 30 defines a common terminal apparatus and preferably executes processes of generating, recording, storing, transmitting, and receiving plain text e-mails, image data, and character data, for example. The client PC 30 preferably includes a main control unit 101, a Read Only Memory (ROM) 106, a Random Access Memory (RAM) 107, a hard disk drive 108, a display unit 104, an operation unit 105, and a LAN interface 112, and other suitable units. These constituent elements are preferably connected with each other via a bus 113.

More specifically, the main control unit 101 defines a Central Processing Unit (CPU), executes functions of various software, and controls the other constituent elements. The ROM 106 preferably stores, in advance, various software programs that are necessary for operations of the client PC 30 and are executed through the main control unit 101. The RAM 107 preferably includes a Static RAM (SRAM), a Dynamic RAM (DRAM), and a Synchronous DRAM (SDRAM), for example. The RAM 107 is preferably used as a working area of the main control unit 101 and stores temporal data that is generated at the time of program execution.

The hard disk drive 108 defines a storage unit to which a recording medium is inserted, and preferably stores, in advance, application programs to be executed. The hard disk drive 108 preferably stores an e-mail transmission/reception program of the client PC 30, which program defines a control program executed to generate e-mails and transmit/receive e-mails via the S/MIME gateway apparatus 20. Further, the hard disk drive 108 preferably stores a web browser program that is used for viewing web pages provided for e-mail operations through the S/MIME gateway apparatus 20.

The display unit 104 defines a Liquid Crystal Display (LCD) or a Cathode Ray Tube (CRT) display, for example. The display unit 104 preferably displays an operational state of the client PC 30, the e-mails to be transmitted, the received e-mails, and the web pages provided through the S/MIME gateway apparatus 20, for example. The operation unit 105 defines a keyboard and a mouse, for example, that are used to receive the input of character data and instruction commands that are issued to receive the e-mails, for example. The LAN interface 112 is preferably connected with the LAN 70, receives signals and data from the LAN 70, and transmits signals and data to the LAN 70, in order to execute interface processes related to LAN communication, such as signal conversion and protocol conversion.

The client PC 30 preferably transmits created plain text e-mails to the S/MIME gateway apparatus 20. The client PC 30 also preferably transmits an e-mail-reception-requesting command issued to request e-mail reception to the S/MIME gateway apparatus 20, and receives plain text e-mails distributed by the S/MIME gateway apparatus 20 in response to such a command. The e-mail-reception-requesting command may be issued at prescribed time intervals through the e-mail transmission/reception program or in accordance with a prescribed instruction command that is input via the operation unit 105 by a user of the client PC 30 in order to instruct the PC 30 to receive e-mails.

The client PC 30 preferably transmits a Hypertext Transfer Protocol (HTTP) request signal to the S/MIME gateway apparatus 20 in order to view a web page provided for e-mail operations through the S/MIME gateway apparatus 20, receives an HTTP reply signal transmitted from the S/MIME gateway apparatus 20 in response to the HTTP request signal, and displays web page information included in the HTTP reply signal on the display unit 104 by using a web browser.

When an error notification mail indicating that the S/MIME gateway apparatus 20 could not receive an e-mail from the e-mail server apparatus 40 is received, the client PC 30 preferably transmits a reply mail to the S/MIME gateway apparatus 20 in response to such an error notification mail or inputs an e-mail deletion request through the web page provided through the S/MIME gateway apparatus 20. As described later in detail, when the reply mail in response to the error notification mail is received or when the e-mail deletion request is input from the web page, the S/MIME gateway apparatus 20 preferably deletes the e-mail that is on the e-mail server apparatus 40. As a modification example, when the error notification mail is received, the client PC 30 may directly receive the e-mail from the e-mail server apparatus 40 without the e-mail having to travel through the S/MIME gateway apparatus 20.

Next, the configuration of the S/MIME gateway apparatus 20 will now be described with reference to FIG. 3.

The S/MIME gateway apparatus 20 preferably includes a function of transmitting an e-mail received from the client PC 30 to a destination and a function of temporarily receiving an e-mail addressed to a client PC 30 from the e-mail server apparatus 40 and then distributing the received e-mail to the destination client PC 30. Further, the S/MIME gateway apparatus 20 preferably includes a function of generating an error notification mail indicating a reception failure and distributing the generated mail to the destination client PC 30 when the S/MIME gateway apparatus 20 fails to receive the e-mail from the e-mail server apparatus 40, and a function of deleting the reception-failed e-mail from the e-mail server apparatus 40 in response to an instruction transmitted from the client PC 30. The S/MIME gateway apparatus 20 includes a main control unit 1, a ROM 6, a RAM 7, a Compactflash (CF: registered trademark) memory 9, and a LAN interface 12. These constituent elements are connected with each other via a bus 13.

More specifically, the main control unit 1 defines a CPU, executes functions of various software to be described later, and controls the other constituent elements. The ROM 106 preferably stores, in advance, various software programs that are necessary for operations of the S/MIME gateway apparatus 20 and are executed through the main control unit 1. The RAM 107 is preferably used as a working area of the main control unit 1 and stores temporal data that is generated at the time of program execution. In particular, in a storage area on the RAM 7, a plurality of user mail boxes 8-1 through 8-N (hereinafter, collectively referred to as the “mail box 8”), a reception-failed-email database 10, and an e-mail deletion User Interface (UI) module 11 are preferably provided.

The user mail boxes 8-1 through 8-N respectively correspond to the client PCs 30-1 through 30-N. Each of the user mail boxes 8-1 through 8-N preferably includes a size of approximately 20 megabytes (MB), for example, and stores, with respect to the respective client PCs 30-1 through 30-N, a plain text e-mail obtained by performing a decryption process or an electronic signature validating process on an encrypted e-mail received from the e-mail server apparatus 40 or stores the error notification mail generated through the S/MIME gateway apparatus 20.

The reception-failed-email database 10 is preferably arranged to register and store information that is used to identify reception-failed-emails transmitted from the e-mail server apparatus 40. The e-mail deletion UI module 11 defines a program of a web server arranged to generate a web page arranged to input to the client PC 30 the e-mail deletion request issued to delete the e-mail that is on the e-mail server apparatus 40 when there is the reception-failed-e-mail transmitted from the e-mail server apparatus 40. The e-mail deletion UI module 11 preferably transmits the HTTP reply signal including the web page information to the client PC 30 in response to the HTTP request signal transmitted from the client PC 30.

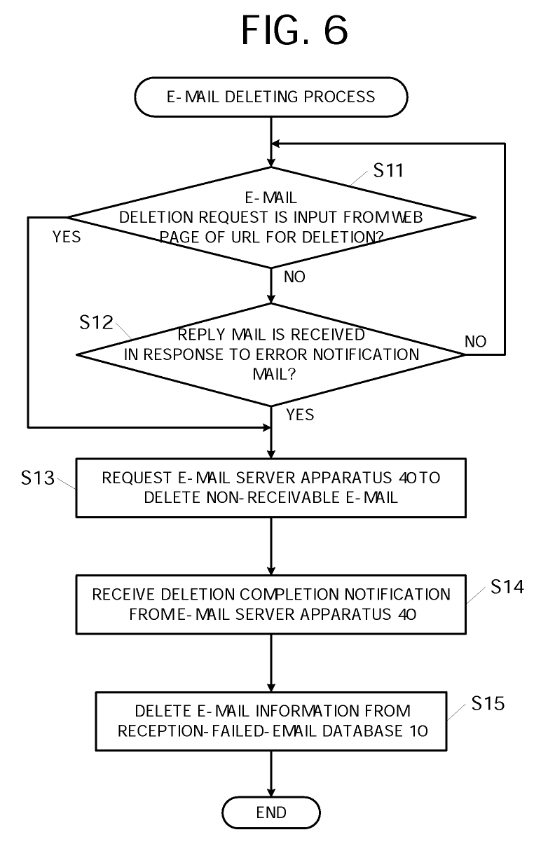

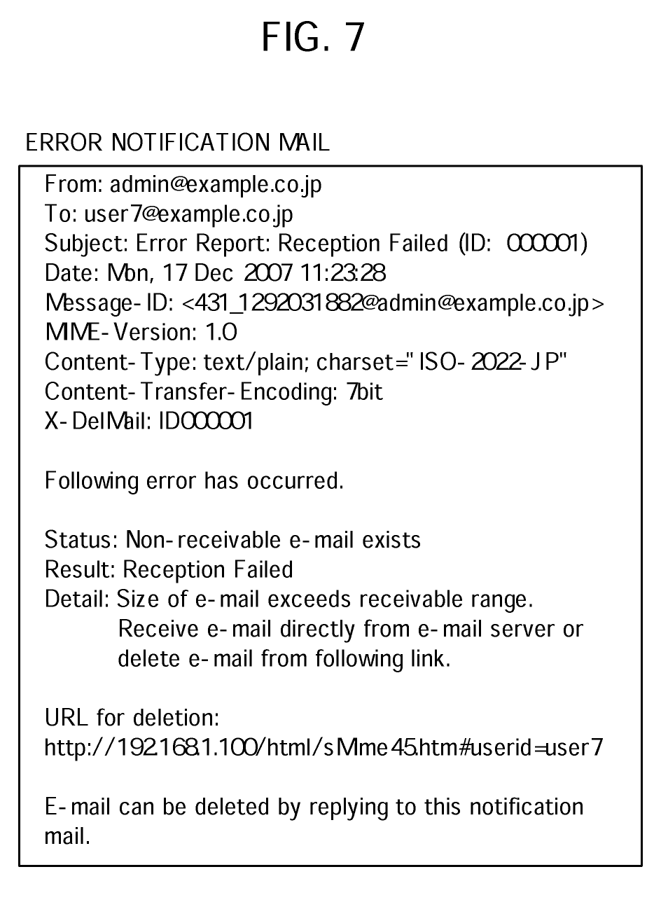

The RAM 7 preferably includes an SRAM, DRAM, and SDRAM, for example. In the case of using a flash memory as the RAM 7, the data contents thereof are not lost even when the power is cut off due to power failure or relocation of the apparatus, or the like. The CF memory 9 preferably stores various data and programs in advance and, in the present preferred embodiment, stores at least programs of an e-mail receiving process (FIG. 6) and an e-mail distributing process (FIG. 7) of the S/MIME gateway apparatus 20. It should also be noted that other nonvolatile storage media may be used in place of the CF memory 9. The LAN interface 12 is preferably connected to the LAN 70, receives signals and data from the LAN 70, and transmits signals and data to the LAN 70, in order to execute interface processes related to LAN communication, such as signal conversion and protocol conversion.

When transmitting the plain text e-mails received from the client PC 30 to a destination, the S/MIME gateway apparatus 20 preferably performs an electronic signature process and an encryption process through software in accordance with S/MIME on the plain text e-mails received from each of the client PCs 30 and transmits the processed e-mails to the e-mail server apparatus 40 thereafter. When the S/MIME gateway apparatus 20 temporarily receives e-mails addressed to the client PCs 30 from the e-mail server apparatus 40 and distributes the e-mails to the destination client PCs 30, the S/MIME gateway apparatus 20 requests the e-mail server apparatus 40 to transmit the e-mails addressed to each of the client PCs 30. The request is preferably set to be executed regularly, for example, at prescribed time intervals.

The S/MIME gateway apparatus 20 preferably receives the encrypted e-mails having the respective electronic signatures transmitted from the e-mail server apparatus 40 in response to the request and executes an electronic signature validating process and a decryption process through software in accordance with S/MIME to convert the received e-mails into plain text e-mails. Then, the S/MIME gateway apparatus 20 preferably stores the plain text e-mails in the user mail box 8 that corresponds to the destination client PC 30.

However, when a size of the received e-mail exceeds the free space of the user mail box 8 that corresponds to the destination user client PC 30 or a threshold value (for example, approximately 5 MB), the S/MIME gateway apparatus 20 cannot receive the e-mails from the e-mail server apparatus 40. At this time, the S/MIME gateway apparatus 20 preferably generates the error notification mail indicating the failure of the reception from the e-mail server apparatus 40, and then stores the generated error notification mail in the user mail box 8 that corresponds to the destination client PC 30. At the same time, the S/MIME gateway apparatus 20 preferably registers in the reception-failed-email database 10 the information that is used for identifying the reception-failed e-mail transmitted from the e-mail server apparatus 40. Further, the S/MIME gateway apparatus 20 may transmit the error notification mail to a transmission source of the reception-failed e-mail.

Further, when the e-mail-reception-requesting command is received from each of the client PCs 30, the S/MIME gateway apparatus 20 preferably distributes the e-mail or the error notification mail stored in the corresponding user mail box 8 to the client PC 30 that is the transmission source of the e-mail-reception-requesting command. In other words, the S/MIME gateway apparatus 20 functions as a Simple Mail Transfer Protocol (SMTP) server apparatus and a Post Office Protocol Ver. 3 (POP3) server apparatus with respect to each of the client PCs 30 and functions as an SMTP client apparatus and a POP 3 client apparatus with respect to the e-mail server apparatus 40.

When there is a reception-failed e-mail transmitted from the e-mail server apparatus 40, the S/MIME gateway apparatus 20 preferably provides in the error notification mail a method for deleting the reception-failed e-mail that is on the e-mail server apparatus 40. In the present preferred embodiment, as one method for deletion, a web page for inputting the e-mail deletion request to the client PC 30 is generated through the S/MIME gateway apparatus 20.

A Uniform Resource Locator of the web page (hereinafter, referred to as the “URL for deletion”) is preferably described in the error notification mail. More specifically, when the URL for deletion is clicked by the user of the client PC 30, a first HTTP request signal is preferably generated and transmitted from the client PC 30 to the S/MIME gateway apparatus 20.

Then, the e-mail deletion UI module 11 of the S/MIME gateway apparatus 20 preferably generates a web page including a menu that is used to determine whether or not to delete the reception-failed e-mail, and transmits a first HTTP reply signal including the information about the generated web page to the client PC 30. Having received the first HTTP reply signal, the client PC 30 preferably displays the information about the web page included in the first HTTP reply signal by using a web browser.

When the e-mail deletion request is input by the user of the client PC 30 through the web page, a second HTTP request signal including the deletion request is preferably generated and transmitted from the client PC 30 to the S/MIME gateway apparatus 20. Then, a second HTTP reply signal is transmitted to the client PC 30 through the e-mail deletion UI module 11 of the S/MIME gateway apparatus 20 in response to the second HTTP request signal.

In the present preferred embodiment, as another method for deletion, a reply mail responding to the error notification mail is transmitted from the client PC 30 to the S/MIME gateway apparatus 20. In such a case, in order to identify that the error notification mail and the reply mail responding thereto are related to the deletion of a specific e-mail that is on the e-mail server apparatus 40, the error notification mail preferably includes, in at least one of a subject name (the section “Subject”) and an extension e-mail header (for example, the section “X-DelMail”), identification information of the e-mail registered in the reception-failed-email database 10, and the reply mail responding to the error notification mail preferably includes a subject name and/or an extension e-mail header having the same identification information therein.

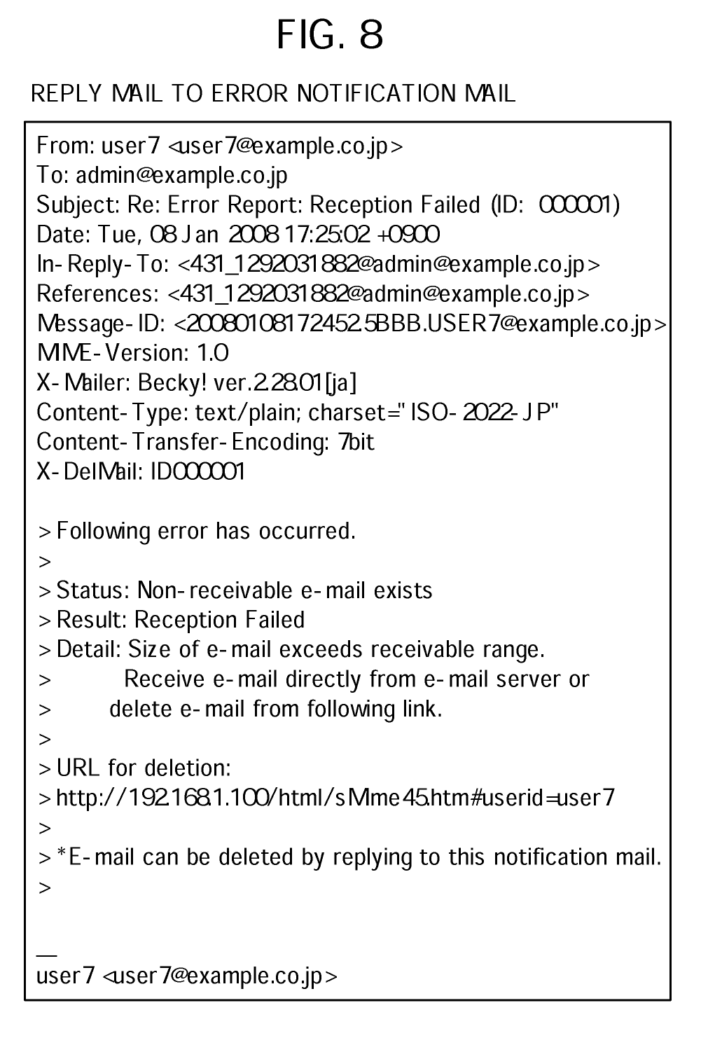

FIG. 7 illustrates an example of the error notification mail transmitted from the S/MIME gateway apparatus 20 to the client PC 30 of FIG. 1. FIG. 8 illustrates an example of the reply mail transmitted from the client PC 30 to the S/MIME gateway apparatus 20 of FIG. 1 in response to the error notification mail of FIG. 7. The error notification mail of FIG. 7 preferably includes an identification information ID “000001” in the section “subject name” and identification information “ID000001” in the section of the extension e-mail header “X-DelMail”. The reply mail of FIG. 8 also preferably includes the identification information ID “000001” in the section “subject name” and the identification information “ID000001” in the section of the extension e-mail header “X-DelMail”. When identifying the error notification mail and its reply mail through the extension e-mail header, the e-mail transmission/reception program of the client PC 30 needs to describe the information of the received extension e-mail header “X-DelMail:ID000001” directly in the reply mail.

When the e-mail deletion request is input from the web page of the URL for deletion, or when the reply mail is received in response to the error notification mail, the S/MIME gateway apparatus 20 preferably requests the e-mail server apparatus 40 to delete the reception-failed e-mail, and deletes the information about the e-mail from the reception-failed-email database 10 after a deletion completion notification is received from the e-mail server apparatus 40.

Next, the configuration of the e-mail server apparatus 40 will be described with reference to FIG. 4.

In FIG. 4, the e-mail server apparatus 40 defines a common e-mail server apparatus, and preferably executes an e-mail transmitting/receiving process. The e-mail server apparatus 40 preferably includes a main control unit 401, a ROM 406, a RAM 407, a hard disk drive 408, a display unit 404, an operation unit 405, a LAN interface 412 connected to the LAN 70, and another interface 414 connected to the Internet 90. These constituent elements are connected with each other via a bus 413. A single interface may be used as the LAN interface 412 and the interface 414.

More specifically, the main control unit 401 defines a CPU, executes functions of various software programs, and controls the other constituent elements. The ROM 406 preferably stores, in advance, various software programs that are necessary for operations of the e-mail server apparatus 40 and are executed through the main control unit 401. The RAM 407 is preferably used as a working area of the main control unit 401 and stores temporal data that is generated at the time of program execution. In particular, a mail box 402 arranged to store e-mails addressed to each of the client PCs 30 is preferably provided in a storage area of the RAM 407. The RAM 407 preferably includes an SRAM, a DRAM, and an SDRAM, for example. In the case of using a flash memory as the RAM 7, the data contents thereof are not lost even when the power is cut off due to power failure or relocation of the apparatus, or the like.

The hard disk drive 408 defines a storage unit to which a recording medium is inserted, and preferably stores, in advance, application programs to be executed. In particular, the hard disk drive 408 preferably stores an e-mail transmission/reception program of the e-mail server apparatus 40, which program defines a control program executed to transmit/receive encrypted e-mails having the respective electronic signatures to/from the S/MIME gateway apparatus 20. The display unit 404 defines an LCD or a CRT display, for example. The display unit 404 preferably displays an operational state of the e-mail server apparatus 40, for example. The operation unit 405 defines a keyboard, for example, that is used to receive the input of character data and instruction commands that are issued to receive the e-mails, for example.

The LAN interface 412 preferably receives signals and data from the LAN 70 and transmits signals and data to the LAN 70, in order to execute interface processes related to LAN communication, such as signal conversion and protocol conversion. Further, the interface 414 preferably receives signals and data from the Internet 90 and transmits signals and data to the Internet 90, in order to execute interface processes related to Internet communication, such as signal conversion and protocol conversion.

The e-mail server apparatus 40 preferably transmits encrypted e-mails having respective electronic signatures transmitted from the S/MIME gateway 20 to an e-mail server apparatus (not illustrated) of a transmission destination via the Internet 90. The e-mail server apparatus 40 also preferably receives encrypted e-mails having respective electronic signatures from an e-mail server apparatus (not illustrated) of a transmission source and stores the received e-mails in the mail box 402. Further, when requested by the S/MIME gateway apparatus 40, the e-mail server apparatus 40 preferably transmits the e-mails addressed to each of the client PCs 30 to the S/MIME gateway apparatus 20. Furthermore, when requested by the S/MIME gateway apparatus 20 to delete any e-mail the S/MIME gateway apparatus 40 has failed to receive, the e-mail server apparatus 40 deletes the e-mail and transmits a deletion completion notification indicating the deletion completion to the S/MIME gateway apparatus 20. As another modification, when an e-mail reception request is received directly from the client PC 30, the e-mail server apparatus 40 may directly distribute the corresponding e-mail to the client PC 30 without via the S/MIME gateway apparatus 20.

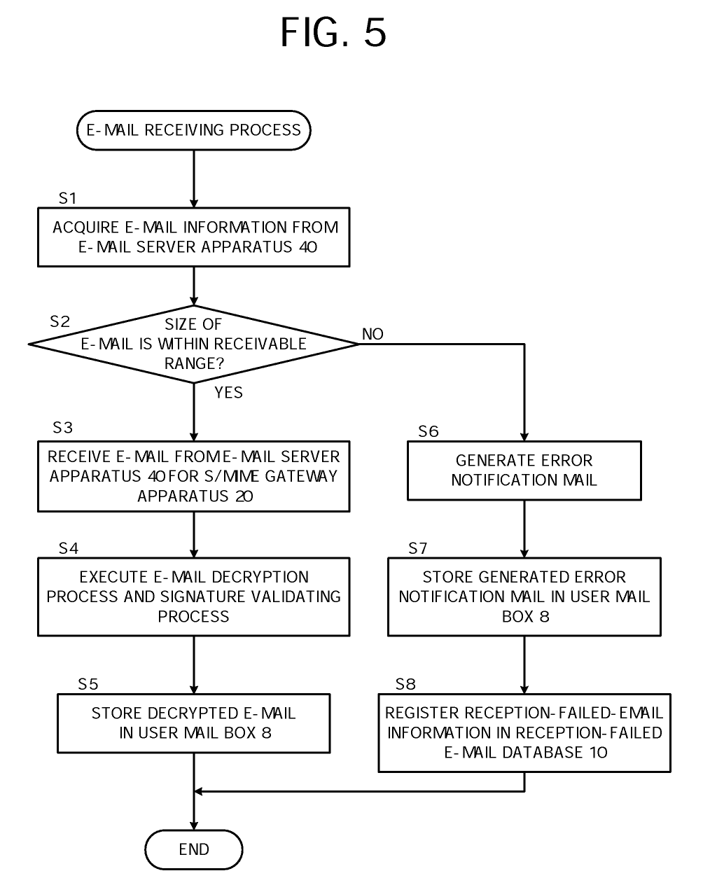

An e-mail receiving process and an e-mail deleting process executed through the main control unit 1 of the S/MIME gateway apparatus 20 of FIG. 3 will now be described with reference to FIGS. 5 and 6.

FIG. 5 is a flowchart representing the e-mail receiving process executed through the main control unit 1 of the S/MIME gateway apparatus 20 of FIG. 3. The main control unit 1 preferably acquires e-mail information from the e-mail server apparatus 40 in step S1. The e-mail information preferably includes at least information indicating whether or not any e-mail addressed to each of the client PCs 30 is in the mail box 402 of the e-mail server apparatus 40, and includes an e-mail size and destination if there is such e-mail(s) in the mail box 402.

The main control unit 1 preferably determines in step S2 whether or not the e-mail size is within a receivable range. In the case of “YES”, the process proceeds to step S3, and in the case of “NO”, the process proceeds to step S6. The main control unit 1 preferably instructs the S/MIME gateway apparatus 20 in step S3 to receive the e-mail from the e-mail server apparatus 40. Then, the main control unit 1 preferably executes the e-mail decryption process and the signature validating process in step S4 and stores the decrypted e-mail in step S5 in the user mail box 8 that corresponds to the destination client PC 30. Thus, the process is ended.

In step S6, the main control unit 1 preferably generates the error notification mail indicating that there is a reception-failed e-mail. The main control unit 1 preferably stores the generated error notification mail in step S7 in the user mail box 8 that corresponds to the client PC that is the destination of the reception-failed e-mail. Then, the main control unit 1 preferably registers information regarding the reception-failed e-mail in the reception-failed-email database 10 in step S8, and ends the process.

FIG. 6 is a flowchart representing the e-mail deleting process executed through the main control unit 1 of the S/MIME gateway apparatus 20 of FIG. 3. The main control unit preferably determines in step S11 whether or not the e-mail deletion request has been input through the web page of the URL for deletion. In the case of “YES”, the process proceeds to step S13, and in the case of “NO”, the process proceeds to step S12. The main control unit 1 preferably determines in step S12 whether or not the reply mail has been received in response to the error notification mail. In the case of “YES”, the process proceeds to step S13, and in the case of “NO”, the process returns to step S11.

The main control unit 1 preferably requests the e-mail server apparatus 40 in step S13 to delete the reception-failed e-mail. Then, the main control unit 1 receives the deletion completion notification from the e-mail server apparatus 40 in step S14, and deletes the information regarding the e-mail from the reception-failed-email database 10 in step S15.

As described above, according to the preferred embodiments of the present invention, when the e-mail from the e-mail server apparatus 40 fails to be received, the main control unit 1 of the S/MIME gateway apparatus 20 distributes the error notification e-mail indicating the failure to the client PC 30. When the deletion request signal requesting the deletion of the reception-failed e-mail is received from the client PC 30, the main control unit 1 requests the e-mail server apparatus 40 to delete the e-mail. Thus, the e-mail gateway apparatus can delete unnecessary e-mails that are on the e-mail server apparatus.

In the above-described preferred embodiments, the S/MIME gateway apparatus 20 and the router apparatus 60 are illustrated preferably as separate apparatuses, however, the apparatuses may be integrated. In the above description, the S/MIME gateway apparatus 20 preferably performs the encryption process and the electronic signature process on each of the e-mails received from the client PCs 30 and performs the decryption process and the electronic signature validating process on each of the e-mails received from the e-mail server apparatus 40 in accordance with S/MIME, however, the present invention is not limited to such preferred embodiments. For example, the S/MIME gateway apparatus 20 may perform the encryption process and the decryption process but not the electronic signature process and the electronic signature validating process. Moreover, in place of the S/MIME gateway apparatus 20, another gateway apparatus may perform the encryption process and the electronic signature process on each of the e-mails received from the client PC 30 and the decryption process and the electronic signature validating process on each of the e-mails received from the e-mail server apparatus 40 in accordance with a Pretty Good Privacy (PGP)/MIME.

As described above, the gateway apparatus according to various preferred embodiments of the present invention can provide the e-mail gateway apparatus that distributes the e-mails from the e-mail server apparatus to the client apparatus and that can delete the unnecessary e-mails that are on the e-mail server apparatus.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An e-mail gateway apparatus comprising:
a reception unit arranged to receive e-mails addressed to client apparatuses from an e-mail server apparatus;
an error notification distribution unit arranged to distribute an error notification mail indicating a failure to the client apparatus when the reception unit fails to receive the e-mail from the e-mail server apparatus; and
a deletion request unit arranged to request the e-mail server apparatus to delete the e-mail when a deletion request signal requesting deletion of the reception-failed e-mail is received.

2. The e-mail gateway apparatus according to claim 1, further comprising a decryption unit arranged to decrypt an e-mail when the e-mail received through the reception unit has been encrypted and to distribute the decrypted e-mail to the client apparatus.

3. The e-mail gateway apparatus according to claim 1, wherein the deletion request signal is a reply mail responding to the error notification mail.

4. The e-mail gateway apparatus according to claim 3, wherein the error notification mail includes identification information that is used to specify the e-mail to be deleted.

5. The e-mail gateway apparatus according to claim 4, wherein the identification information is included in a header of the error notification mail.

6. The e-mail gateway apparatus according to claim 4, wherein the identification information is included in a subject name section of the error notification mail.

7. The e-mail gateway apparatus according to claim 1, further comprising:
a web server unit arranged to generate a web page to receive input from the client apparatus and to transmit a reply signal including the web page to the client apparatus in response to a first request signal transmitted from the client apparatus; wherein
the deletion request signal is a second request signal that is transmitted from the client apparatus and includes a deletion request that is input to the web page through the client apparatus in response to the reply signal.

8. The e-mail gateway apparatus according to claim 7, wherein the error notification mail includes a Uniform Resource Locator that is used to specify the web page.
